(19) United States
(12) Patent Application Publication
(10) Pub. No.: US 2023/0171202 A1
(43) Pub. Date: Jun. 1, 2023

(54) SYSTEM AND METHOD FOR PERFORMING ASSESSMENT OF ELECTRONIC RESOURCES STORED IN A DISTRIBUTED NETWORK

(71) Applicant: BANK OF AMERICA CORPORATION, Charlotte, NC (US)

(72) Inventors: Katherine Kei-Zen Dintenfass, Lincoln, RI (US); Robert Nyeland Huggins, Charlotte, NC (US); Jinna Zevulun Kim, Charlotte, NC (US)

(73) Assignee: BANK OF AMERICA CORPORATION, Charlotte, NC (US)

(21) Appl. No.: 17/539,877

(22) Filed: Dec. 1, 2021

(51) Int. Cl. H04L 47/78; H04L 47/762; H04L 47/80; H04L 47/70; H04L 41/02

(52) U.S. Cl. CPC H04L 47/781; H04L 47/762; H04L 47/808; H04L 47/82; H04L 41/024

(57) ABSTRACT

Embodiments of the invention are directed to a system, method, or computer program product for an approach for performing assessment of electronic resources stored in a distributed network. The system allows for receiving, from a user, an obligation request, identifying and assessing electronic resources associated with the user in a distributed network, and determining a score for the electronic resources using a prediction model. The system also allows for querying and identifying in a database relevant recorded resource transfers, assigning a relevance level for the identified relevant recorded resource transfers, and assigning a score to the electronic resources along with a confidence level.

### BACKGROUND

Currently, entities provide resources to users through obligation requests initiated by users. However, entities are unable to include electronic resources in the obligation request evaluation that occurs prior to issuing the obligation to users. As such, there exists a need for a system and method for performing assessment of electronic resources stored in a distributed network.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for performing assessment of electronic resources stored in a distributed network.

Currently, entities provide resources to users through obligation requests initiated by users. However, entities are unable to include electronic resources in the obligation request evaluation that occurs prior to issuing the obligation to users. The system described herein is able to locate electronic resources in a distributed network owned by a user, determine a projected value of any electronic resource by locating relevant recorded resource transfers in the distributed network using the description and/or the creator of the user's electronic resource. Assign a relevance level for identified relevant recorded resource transfers, model a value forecast and determine a confidence level for the value forecast, as well as assign an overall score to the user's electronic resources. The system is also able to alter or modify the distributed ledger as a result of the obligation such that the ownership of the electronic resource reflects the obligation.

Embodiments of the invention are directed to a system, method, or computer program product for performing assessment of electronic resources stored in a distributed network, the invention comprising receiving, from a user, an obligation request, wherein the obligation request comprises a request from the user for resources; identifying one or more electronic resources associated with the user in a distributed network, wherein ownership of the one or more electronic resources is recorded on a ledger of the distributed network; assessing the one or more electronic resources using a comparison model; determining a score for the one or more electronic resources using a prediction model; calculating a present value and a future value of the one or more electronic resources based on the score; and issuing resources to the user based on the score of the one or more electronic resources.

In some embodiments, the invention is further configured to determine a creator of the one or more electronic resources; determine a description of the one or more electronic resources; query a database of relevant recorded resources transfers using the creator and the description; identify relevant recorded resources transfers in the database of relevant recorded resource transfers associated with the creator or the description; and export a compiled list of the relevant recorded resource transfers.

In some embodiments, or in combination with any of the previous embodiments, the invention is further configured to assign a relevance level for identified relevant recorded resource transfers when compared to the one or more electronic resources; model a value forecast of the one or more electronic resources based on the identified relevant recorded resource transfers; determine a confidence level for the value forecast; and assign a score to the one or more electronic resources, wherein the score comprises the relevance level, the confidence level, and the value forecast.

In some embodiments, or in combination with any of the previous embodiments, the one or more electronic resources is a tokenized resource, and ownership of the tokenized resource is recorded on a ledger of the distributed network.

In some embodiments, or in combination with any of the previous embodiments, the ownership of the tokenized resource is altered in the ledger of the distributed network to describe that the entity possesses a security interest in the tokenized resource.

In some embodiments, or in combination with any of the previous embodiments, the obligation request comprises the user receiving the resources in exchange for the user transferring the resources back to the entity within an agreed-upon timeframe, upon completion of which the user maintains ownership of the one or more electronic resources.

In some embodiments, or in combination with any of the previous embodiments, the obligation request further comprises determining a value of current resources associated with the user, and wherein the score is determined for both the current resources and the one or more electronic resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a network environment in which the processes described herein are implemented, according to embodiments of the present invention;

FIG. 2A and FIG. 2B illustrate a centralized database and distributed network environment, respectively, in which the processes described herein are implemented, according to embodiments of the present invention;

FIG. 3 is a block diagram of a method for performing assessment of electronic resources stored in a distributed network;

FIG. 4 is a block diagram of a method for implementing a comparison model for performing assessment of electronic resources stored in a distributed network;

FIG. 5 is a block diagram of a method for scoring electronic resources stored in a distributed network; and

FIG. 6 is a block diagram of a method for altering the distributed ledger of electronic resources stored in a distributed network as a result of an obligation.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Embodiments of the invention are directed to a system, method, or computer program product for performing assessment of electronic resources stored in a distributed network. The system allows for a user to request an obligation to an entity such that the entity is able to assess the one or more electronic resources associated with the user on a distributed network as part of the obligation request. In this way, the entity may be able to issue resources to the user after assessing the value of the one or more electronic resources associated with the user to determine the time period for the obligation, interest rate, user qualifications, or the like. The system is configured to locate relevant resource transfers on a distributed network involving electronic resources similar to the one or more electronic resources associated with the user and return an estimated value for each electronic resource and one or more confidence ratings for the estimated value. The estimated value and/or confidence rating(s) may be used by the entity to determine the entity's willingness to fulfill the obligation request.

A “user” as used herein may refer to any entity or individual associated with the distributed network system. In some embodiments, a user may be a computing device user, a phone user, a mobile device application user, a financial institution customer (e.g., an account holder or a person who has an account (e.g., banking account, credit account, or the like)), a system operator, database manager, a support technician, and/or employee of an entity. In some embodiments, identities of an individual may include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

In accordance with embodiments of the invention, the term “entity” may be used to include any organization or collection of users that may interact with a distributed network. An entity may refer to a business, company, or other organization that either maintains or operates the system or requests use and accesses the system. “Entity” may be used to include any organization that processes financial transactions including, but not limited to, banks, credit unions, savings and loan associations, investment companies, stock brokerages, resource management firms, insurance companies or the like.

The term “distributed network,” as used herein, refers to a plurality of computer systems known as “nodes”, each of which is in communication with one or more of the other nodes. Nodes may write a data “block” to a distributed ledger, the block comprising data regarding a resource transfer, electronic resource ownership, or the like. The blocks further comprising data and/or metadata. In some embodiments, only designated “miner” nodes may write resource transfers to the distributed ledger. In other embodiments, all nodes have the ability to write to the distributed ledger. In some embodiments, the block may further comprise a time stamp and a pointer to the previous block in the chain. In some embodiments, the block may further comprise metadata indicating the node that was the originator of the resource transfer. In this way, an entire record is not dependent on a single database which may serve as a single point of failure; the distributed network will persist so long as the nodes on the distributed network persist.

The term “distributed ledger” as used herein, refers to a decentralized electronic ledger of blocks which are authenticated by a federated consensus protocol, a copy of which is stored on multiple nodes of the distributed network. Multiple computer systems within the distributed network each comprise a copy of the entire ledger of records. Embodiments of the invention as described herein may utilize one, several, or a combination (i.e. hybrid) of a number of different consensus algorithms to ensure the integrity of the distributed ledger within the block chain. In some embodiments, the consensus mechanism may be a “proof of work” (“PoW”) protocol, in which the nodes perform a series of calculations to solve a cryptographic puzzle. In other embodiments, the consensus mechanism may be a “proof of stake” (“PoS”) protocol or delegated proof of stake protocol. For instance, in order to validate a pending data record, the nodes may be required to calculate a hash via a hash algorithm (e.g. SHA256) which satisfies certain conditions set by the system. Calculating a hash in this way may be referred to herein as “mining,” and thus a node performing the mining may be referred to as “miners” or “miner nodes.”

As used herein, a “resource” refers to any fungible or liquid resource, currency, cryptocurrency, investments, or the like. In this way, a resource may be used by a user or an entity as collateral or proof of worth for securing an obligation through use of an obligation request.

As used herein, an “obligation request” occurs when a user may need additional resources for uses such as purchasing real estate, seeking higher education, opening a business, or the like. A user may approach an entity with an obligation request for these additional resources and the entity may require proof of current resources associated with the user in order for the entity to issue additional resources to the user. An entity may note all of the current resources associated with a user and evaluate each resource such that the entity has current values of the resources, future values of the resources, or the like. Additionally, the entity may collect information about the user in order to properly evaluate the user's ability to return the resources at a later date, and thus fulfill the obligation. In this way, the entity may evaluate a user's credit history, net worth, occupation, earnings, or the like. After an entity has collected the information about the user and the information about the resources associated with a user, the entity may calculate a score such that a decision can be made regarding the willingness of an entity to issue the resources to the user, an appropriate interest rate coupled with the resources issued to the user, the time period for the user to return the resources to the entity or the like. As will be discussed in the forthcoming disclosure, an entity may also rely on one or more electronic resources associated with (owned by) a user in addition to the user's current resources in order to decide on the characteristics of the resources issued to a user in response to an obligation request.

As used herein, a “electronic resources” refers to a non-fungible token (“NFT”) or semi-fungible token which comprises ownership of an item in which the ownership is documented and authenticated on a distributed ledger. Ownership, or tokenization, occurs when a “smart contract” is written and distributed along the distributed ledger. In some embodiments, the smart contract is written using a token standard like ERC-721, ERC-1155, or the like. In some embodiments, the electronic resource may comprise digital artwork, videos, digital media, music, or the like. In other embodiments, the electronic resource may be a physical good or item such as clothing, shoes, memorabilia, real estate, vehicles, collectibles, or the like. In some embodiments, the electronic resource is not stored on the distributed ledger or distributed network, rather the documentation of ownership of the electronic resource is verified and recorded on the distributed ledger. In other embodiments, the electronic resource may be stored directly on the distributed ledger alongside the recordation of ownership.

In some embodiments, a “resource transfer” may refer to an exchange of resources between an entity and another entity, a user and another user, or an entity and a user. In some embodiments, a resource transfer may occur and be recorded on a distributed ledger.

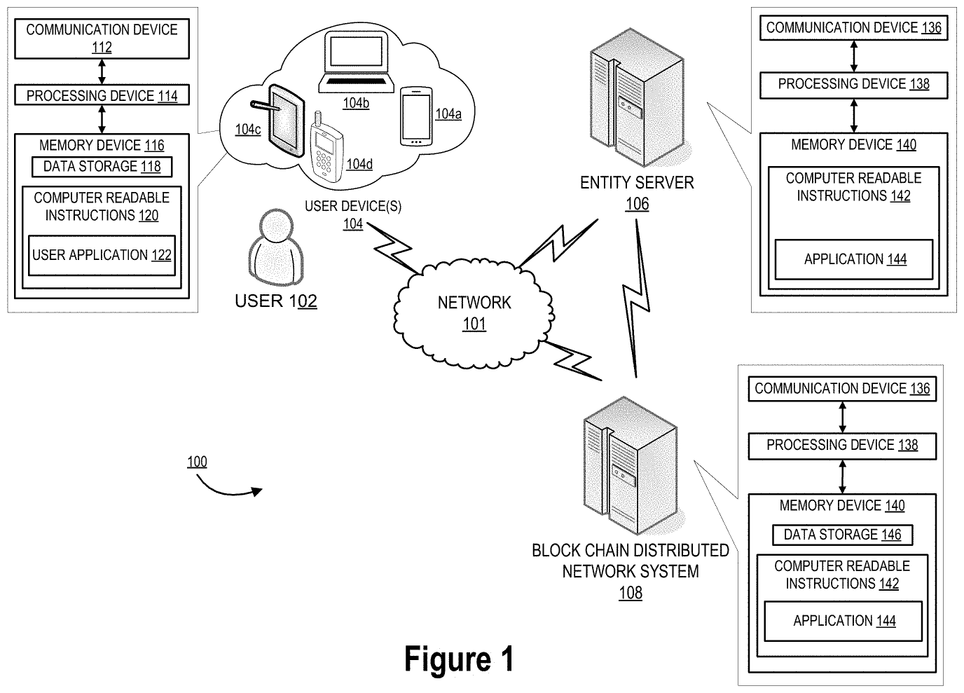

FIG. 1 provides a system that includes specialized systems and devices communicably linked across a distributive network of nodes required to perform a method for performing assessment of electronic resources stored in a distributed network. FIG. 1 provides an environment 100 for the system and, in accordance with one embodiment of the present invention.

As illustrated in FIG. 1, the distributed network system 108 is operatively coupled, via a network 101 to the user device 104, and to the entity server 106. In this way, distributed network system 108 can send information to and receive information from the user device 104, and the entity server 106. FIG. 1 illustrates only one example of the system environment 100, and it will be appreciated that in other embodiments one or more of the systems, devices, or servers may be combined into a single system, device, or server, or be made up of multiple systems, devices, or servers.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network.

In some embodiments, the user 102 is an individual who has the ability and/or authority to access a distributed network, entity, or the like. Those skilled in the art will appreciate that at least some example embodiments contemplate multiple such users. In some embodiments, the user 102 has a user device, such as a mobile phone, tabled, computer or the like. FIG. 1 also illustrates a user device 104. The user device 104 may be any communication device such as a smart phone 104a, a telephone 104d, a tablet 104c, a computer 104b, or the like. The user device 104 generally comprises a communication device 112, a processing device 114, and a memory device 116. The processing device 114 is operatively coupled to the communication device 112 and the memory device 116. The processing device 114 uses the communication device 112 to communicate with the network 101 and other devices on the network 101, such as, but not limited to the distributed network system 108, and the entity server 106. As such, the communication device 112 generally comprises a modem, server, or other device for communicating with other devices on the network 101.

As further illustrated in FIG. 1, the user device 104 comprises computer-readable instructions 120 stored in the memory device 116, which in one embodiment includes the computer-readable instructions 120 of a user application 122 and data storage 118. A user device 104 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, voice assistants, laptop computers, cameras, video recorders, audio/video player, radio, GPS devices, any combination of the aforementioned, or the like. Although only one user device 104 is depicted in FIG. 1, the system environment 100 may comprise a plurality of mobile devices 104. In some embodiments of the invention described herein, a plurality of user devices 104 is used. In other embodiments, user devices 104 are not necessary for the functionality of the system and may not be integrated into the system in any appreciable manner. In yet additional embodiments, user devices 104 may be utilized for checking the status of a resource transfer or the like.

As illustrated in FIG. 1, the distributed network system 108 generally comprises a communication device 136, a processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the entity server 106, and the user device 104. As such, the communication device 136 generally comprises a modem, server, or other device for communicating with other devices on the network 101.

As further illustrated in FIG. 1, the distributed network system 108 comprises computer-readable instructions 142 stored in the memory device 140, which in one embodiment includes the computer-readable instructions 142 of an application 144. In some embodiments, memory device 140 includes data storage 146 for storing data related to the system environment, but not limited to data created and/or used by the application 144.

Embodiments of the distributed network system 108 may include multiple systems, servers, computers or the like maintained by one or many entities. FIG. 1 merely illustrates one of those systems that, typically, interacts with many other similar systems to form the distributed network and thereby has the ability to work on the distributed ledger, either in an authorizing or modifying capacity. In one embodiment of the invention, the distributed network system 108 is operated by a second entity that is different or separate entity from the entity server 106. In some embodiments, the entity server 106 may be part of the distributed ledger. Similarly, in some embodiments, the distributed network system 108 is part of the entity server 106. In other embodiments, the entity server 106 is distinct from the distributed network system 108.

In one embodiment of the distributed network system 108 the memory device 140 stores, but is not limited to, an application 144 and a distributed ledger. In some embodiments the distributed network stores data including, but not limited to, smart identification logic and rules, user identifications, user legal identification, associated logic and rules, resource allocation rules, resource allocation data, one or more electronic resources rules, user one or more electronic resources data, one or more electronic resources associated with a user, user obligation satisfaction probability, related data, or the like. In one embodiment of the invention, both the application 144 and the distributed network may associate with the applications having computer executable program code that instructs the processing device 138 to operate the communication device 136 to perform certain communication functions described herein. In one embodiment, the computer-executable program code of an application associated with the distributed network and application 144 may also instruct the processing device 138 to perform certain logic, data processing, and data storage functions of the application.

The processing device 138 is configured to use the communication device 136 to gather data, such as data corresponding to resource transfers, one or more electronic resources assignment, blocks, or other updates to the distributed ledger from various data sources such as other distributed network systems. The processing device 138 stores the data that it receives in its copy of the distributed ledger stored in the memory device 140.

In the embodiment illustrated in FIG. 1 and described throughout much of this specification, the application 144 may generate a method and attribute required for scoring electronic resources associated with a user and/or verifying the ownership of electronic resources on a complete or partial basis on a distributed network. In this way, the application 144 generates a check on the ownership of one or more electronic resources. The application 144 may also parse the distributed ledger for similar one or more electronic resources or relevant recorded resource transfers for electronic resources similar to the one or more electronic resources associated with the user. In doing so, the application 144 may compile a list of references to one or more electronic resources not associated with a user, but instead associated with other users and accompanied with relevant recorded resource transfers for the electronic resources associated with other users, and as such may compile the list for valuation purposes.

The application 144 may not store electronic resources, but instead may store a guarantee that one or more electronic resources exists, is associated with a user claiming ownership of the electronic resource, or the like, as ascertained from the distributed ledger. As such, the application 144 may receive and store electronic resource information (and/or electronic resource ownership information) either those electronic resources associated with a user or electronic resources associated with other users, data associated with resource transfers such as time of ownership transfer, resources transferred during the ownership transfer or previous ownership transfers, data extracted from documentation associated with an electronic resource such as creator, description, descriptive tags, electronic resource size, electronic resource storage location, the ownership of an electronic resource, or the like.

While application 144 may be configured to parse and query a distributed ledger of a distributed network in order to ascertain the aforementioned information regarding one or more electronic resources, it shall be understood that the application 144 may also be configured, in some embodiments of the invention, to utilize databases and ledgers stored outside of the distributed network in order to guarantee that an electronic resources exists, is associated with a user claiming ownership of the electronic resource, or the like. The application 144 may receive and store electronic resource information from databases and ledgers outside of the distributed network such as online webpages, online auction houses, 3^{rd} party retail stores or webpages, or the like. These locations outside of the distributed network may provide information regarding the electronic resources associated with a user or electronic resources associated with other users, data associated with resource transfers such as time of ownership transfer, resource amount transferred during the ownership transfer or previous ownership transfers, data extracted from documentation associated with electronic resources such as creator, description, descriptive tags, electronic resource size, electronic resource storage location, the ownership of an electronic resource, or the like.

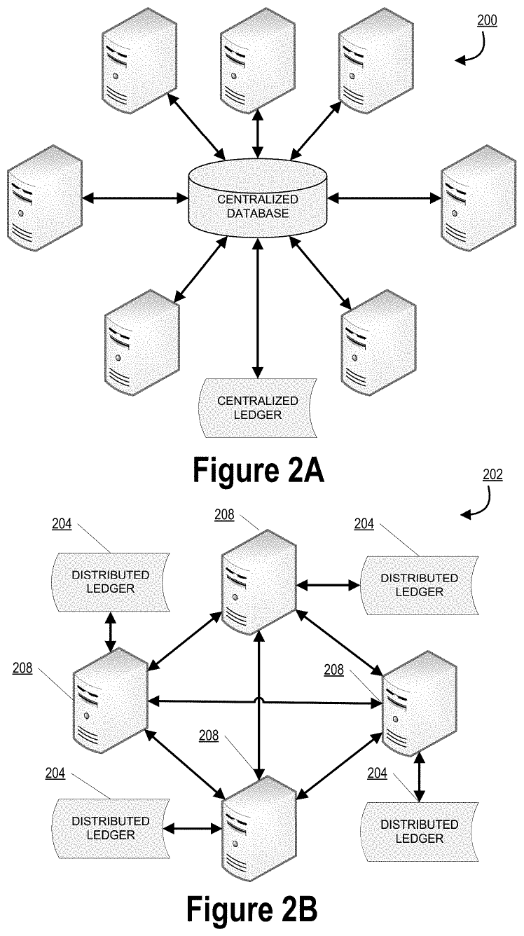

The application 144 may receive and/or confirm with other entities the ownership of electronic resources through interaction with other entities. In this way, the distributed network database connects with other entities. A distributed network typically includes sever nodes, which may be one or more systems, machines, computers, databases, data stores, or the like, operably connected with one another which is further illustrated below in FIG. 2B. The nodes in the distributed network may be entities that function as gateways for other entities.

In some embodiments disclosed herein, application 144 may also be configured to execute a scoring algorithm using the information gathered (either within the distributed network or outside of the distributed network) regarding the electronic resources associated with the user and/or relevant recorded resource transfers of electronic resources associated with other users. application 144 may take information such as ownership information, resource transfer or sales history of any one or more electronic resources similar to the one or more electronic resources presented by the user during an obligation request. In this way, application 144 may execute to compile electronic resources and/or the relevant recorded resource transfers associated thereof, with the same or similar creator, attributes, description, features, retail category, geographic location, or the like. As one non-limiting example, a user may wish to provide an electronic resource such as digital artwork as evidence of a resource during an obligation request made by a user to an entity. The application 144 may gather details regarding the electronic resource such as the creator, the subject-matter of the one or more electronic resources, the time at which it was created, the size, or the like. application 144 may then conduct a search of all available databases for other digital artwork from the same or similar creator with the same or similar subject-matter. application 144 may then proceed by compiling sales or resource transfer history for each of the identified similar digital artwork. Using this information, application 144 is configured to estimate the current value of the one or more electronic resources as well as a projected value of the electronic resource at some point in the future. Application 144 may utilize any type of statistical modeling or mathematical forecasting technique to determine the future value of the electronic resource including, but not limited to, linear extrapolation, averaging, polynomial extrapolation, conic extrapolation, French curve extrapolation, geometric extrapolation (with or without error prediction), or the like. Furthermore, application 144 may be configured to calculate a confidence level for the forecast such that the projected future value and/or present value is coupled with an indication of how certain the application 144 is of the future and/or present value. As such, predictions for future and/or present value may be weighed by the application 144 or the entity such that predictions with low confidence intervals are given less weight than predictions with higher confidence intervals.

As illustrated in FIG. 1, the entity server 106 is connected to the distributed network system 108 and is associated with an entity network. In this way, while only one entity server 106 is illustrated in FIG. 1, it is understood that multiple network systems may make up the system environment 100. The entity server 106 generally comprises a communication device 136, a processing device 138, and a memory device 140. The entity server 106 comprises computer readable instructions 142 stored in the memory device 140, which in one embodiment includes the computer readable instruction 142 of an application 144. The entity server 106 may communicate with the distributed network system 108 to provide real-time resource availability for a user account.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 2A illustrates a centralized database architecture environment 200, in accordance with one embodiment of the present invention. The centralized database architecture comprises multiple nodes from one or more sources and converge into a centralized database. The system, in this embodiment, may generate a single centralized ledger for data received from the various nodes. FIG. 2B provides a general distributed network system environment architecture 202, in accordance with one embodiment of the present invention. Rather than utilizing a centralized database of data for recording ownership or assignment of electronic resources, as discussed above in FIG. 2A, various embodiments of the invention may use a decentralized distributed network configuration or architecture (block chain) utilizing a distributed ledger as shown in FIG. 2B.

A distributed ledger is a distributed database that maintains a list of data blocks, such as real-time resource availability associated with one or more users or the like, the security of which is enhanced by the distributed nature of the distributed network. A distributed network typically includes several nodes, which may be one or more systems, machines, computers, databases, data stores or the like operably connected with one another. In some cases, each of the nodes or multiple nodes are maintained by different entities. A distributed network typically works without a central repository or single administrator. One well-known application of a distributed network is the public ledger of resource transfers for cryptocurrencies. Another well-known application of a distributed network is the recordation and tokenization of transfers in ownership of artwork, memorabilia, videos, photos, physical merchandise, real estate, or the like, known as tokenized resources, which may comprise NFTs, but also may comprise other forms of electronic resources. The data blocks recorded in the distributed network are enforced cryptographically and stored on the nodes of the distributed network.

A distributed network provides numerous advantages over traditional databases. A large number of nodes of a distributed network may reach a consensus regarding the validity of a resource transfer, such as those which occur during transfer of ownership of an electronic resource, contained on the resource transfer ledger. As such, the status of the resources associated any user can be validated and cleared by one participant.

As mentioned above and referring to FIG. 2B, a distributed network system 202 is typically decentralized—meaning that a distributed ledger 204 is maintained on multiple nodes 208 of the distributed network 202. One node in the distributed network may have a complete or partial copy of the entire ledger or set of resource transfers and/or blocks on the distributed ledger. Recorded resource transfers in some distributed ledgers 204 may comprise information regarding ownership, electronic resource creator information, electronic resource description, time stamps, resource transfer amount, hyperlinks or secure links to the electronic resources, photos, graphics, or the like. Resource transfers are initiated at a node of a distributed network and communicated to the various nodes of the distributed network. Any of the nodes can validate a resource transfer, add the resource transfer to its copy of the distributed ledger, and/or broadcast the resource transfer, its validation (in the form of a block) and/or other data to other nodes. This other data may include time-stamping, such as is used in some distributed ledgers.

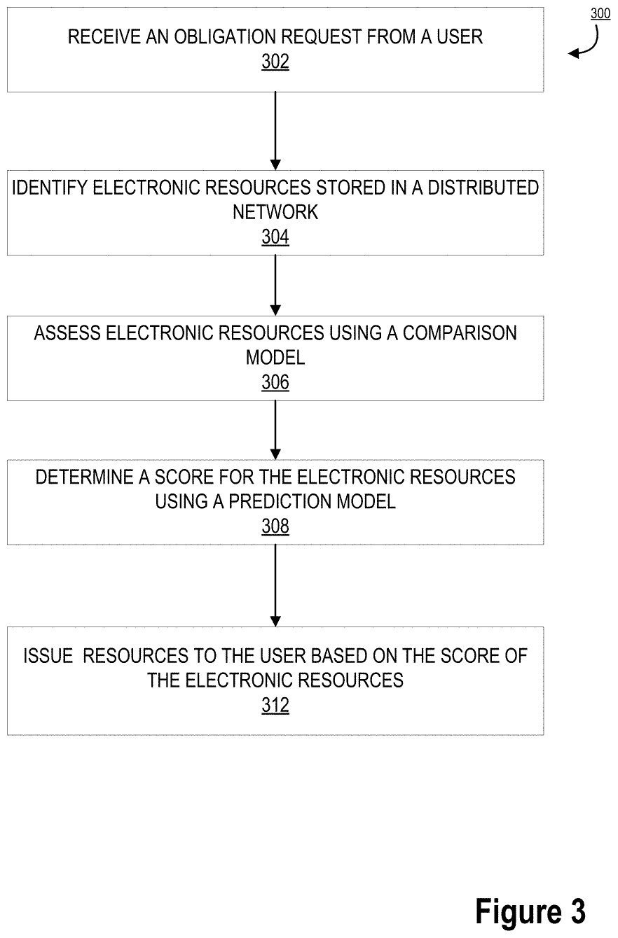

FIG. 3 illustrates a block diagram 300 of a system and method for performing assessment of one or more electronic resources stored in a distributed network, in accordance with some embodiments of the present invention. As illustrated in block 302, the system receives an obligation request from a user. As previously described, this typically comprises a user with one or more current resources who requests for an entity to provide additional resources to the user for a specific amount of time (or in some embodiments, indefinitely), such that the user may use the resources from the entity for various purposes such as buying a home, opening a business, purchasing a vehicle, paying expenses, or the like. Upon receiving the obligation request from the user, the entity is tasked with determining the viability of the user as a borrower, in order to gauge the entity's receptiveness to issuing the resources to the user. In some embodiments, the entity may use information about the user to make such a determination such as the value of the resources currently in possession by the users, the earnings of the user, real resources associated with the user, or the like. In some embodiments, the entity may take the information about a user's current resources in order to determine an interest rate, period for fulfilling the obligation request for the resources, or the like.

In some embodiments, the user may make an obligation request to an entity via a request instigated by the entity, in such cases where the user is physically speaking with a user associated with the entity. In other embodiments, the user may input an obligation request into a user device, such that the user is the one making the obligation request. In this way, a user may be able to request the obligation using any number of user devices in communication with an entity via a channel such as a computer, voice enabled assistant, mobile phone, telephone, or the like. In some embodiments, the obligation request comprises the user specifying the amount of the obligation request, the intended use of the resources to be issued as a result of the obligation request, the requested time period for fulfilling the obligation request, or the like.

In block 304, the process continues by identifying the one or more electronic resources stored in a distributed network. In some embodiments, the system is configured to identify electronic resources wherein the ownership of the electronic resources is noted and stored in a distributed ledger of a distributed network. As such, the system may be capable of searching the distributed ledger for specific ownership information associated with a user or other users. Ownership information may comprise party names, resource transfer information such as amounts of resource transfer, timestamps, or the like. Furthermore, ownership information may comprise timestamp information, creator and/or description information for the electronic resource, hyperlink or embedded images/graphics of the electronic resource, or the like. Similarly, some embodiments may be configured to search the distributed ledger for ownership information of any number of other electronic resources associated with any user. Specifically, ownership information is used by the entity receiving the obligation request to validate and/or verify that the one or more electronic resources is indeed associated with the user. In this way, the entity is able to calculate the appropriate likelihood for the resources issued to fulfill the obligation request.

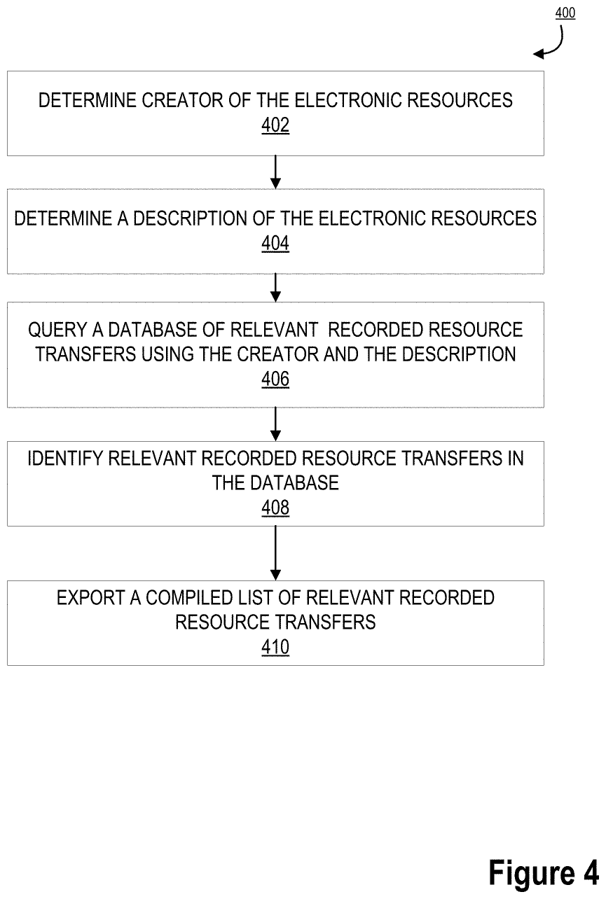

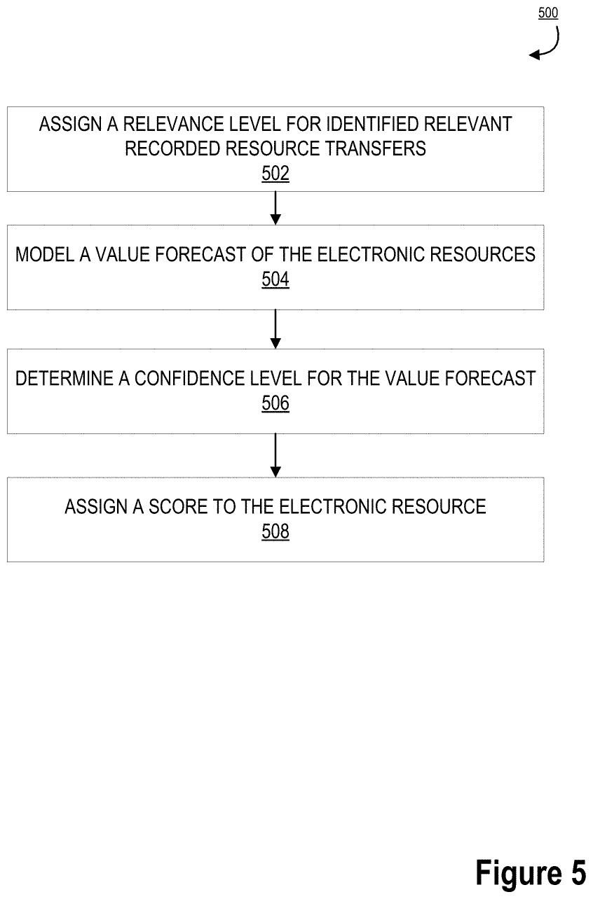

Using the one or more electronic resources located and verified in block 304, the system may now be configured to assess the electronic resources using a comparison model as illustrated in block 306. The system uses information received from the identification in block 304 to begin an assessment against similar or like types of electronic resources in the distributed ledger which can aid in determining the value of the electronic resources(s) associated with the user. The system may be configured to do so by querying the distributed ledger for relevant recorded resource transfers of similar electronic resources. In this way, the system may determine a future value, such that the value of the one or more electronic resources may be predicted or estimated for any given length of time. In this way, the system may also calculate a current value of the one or more electronic resources, or the value in 30 days, 6 months, 1 year, 2 years, 5 years, or the like. It should be understood that any given length of time may be used in such an evaluation. Additional details pertaining to the system assessing the one or more electronic resources using a comparison model are explained in further detail in FIG. 4 and FIG. 5.

The process continues with block 308, in which the system determines a score for the one or more electronic resources using a prediction model. The system is configured to determine and provide a score for the electronic resource(s) in order for the entity who is fulfilling the obligation request to determine the entity's willingness associated with distributing resources based on several factors. The factors include, but are not limited to, current value of the one or more electronic resources(s), future value of the one or more electronic resources(s), volatility in the market for any given sector of electronic resources, confidence interval for the prediction of the future and present values of the one or more electronic resources, ratio between the obligation amount and the predicted value of the one or more electronic resources, or the like. In some embodiments a high score may be given to electronic resources where the system has determined a high probability with high confidence that the value of the electronic resource at the end of the obligation term is higher than the obligation amount. In some embodiments a low score may be given to electronic resources where the system has determined a low probability with high confidence that the value of the electronic resources at the end of the obligation term is higher than the obligation amount. Similarly, in some embodiments a medium score may be given to electronic resources where the system has determined a high probability with low confidence that the value of the electronic resources at the end of the obligation term is higher than the obligation amount. In some embodiments a medium score may be given to electronic resources where the system has determined a low probability with low confidence that the value of the electronic resources at the end of the obligation term is higher than the obligation amount.

It should be appreciated that various weights may be given to each factor considered during the scoring process of block 308. In some embodiments, the system may have the ability for the entity considering fulfilling the obligation request to change the weights of each factor on a case-by-case scenario, depending on a multitude of factors including general market outlook, electronic resources market outlook, individual user obligation history, entity financial outlook, or the like.

The process illustrated in FIG. 3 concludes with block 312, wherein the entity issues resources to the user associated with the obligation request based at least partially on the score of the electronic resources. In some embodiments, the user receives the resources in an account associated with the entity. In other embodiments, the user may receive a check, wire transfer, or the like. In yet additional embodiments, the user may not directly receive the resources themselves, but rather the resources may be transferred to a 3^{rd} party entity such as a merchant, mortgage company, bank, or the like.

FIG. 4 illustrates a block diagram 400 of a method for implementing a comparison model as previously mentioned in FIG. 3. After other processes have identified one or more electronic resources associated with the user, process 400 begins by determining the creator of the electronic resource(s) as illustrated by block 402. In some embodiments, determining the creator may comprise parsing the distributed ledger for the recorded ownership assignments of the electronic resource and exporting the name of the creator and/or assignor. In other embodiments, the system may be configured to search open-source or internal databases to match a file description or filename of the electronic resource to a creator. For example, the creator of an electronic resource associated with the user may be “Leonardo da Vinci”, but this information may not be clearly listed on the distributed ledger. However, this information may be available in the filename or hyperlink of the electronic resource as “LeonardodaVinci_MonaLisa_Painting.jpg”. The system may be configured to allow for recognition of the creator via a list of known creators, such that the system autonomously determines the creator of the work to be Leonardo da Vinci based on the filename and/or hyperlink. The system may also be configured to allow for manual entry of the name of the creator, such that a user associated with an entity may manually recognize and enter the creator name to aid in the steps further described below.

The process continues as illustrated in block 404 by determining the description of the one or more electronic resources associated with the user. In some embodiments, determining the description may comprise parsing the distributed ledger for the recorded ownership assignments of the one or more electronic resources and exporting the description. In other embodiments, the system may be configured to search open-source or internal databases to match a file description or filename of the electronic resource to a description. For example, the creator of an electronic resource associated with the user may be “Leonardo da Vinci”, but this information may not be clearly listed on the distributed ledger. However, this information may be available in the filename or hyperlink of the electronic resource as “LeonardodaVinci_MonaLisa_Painting.jpg”. The system may be configured to allow for recognition of the description via a list of known descriptions, such that the system autonomously determines the description of the work to be a “painting” or “Mona Lisa” based on the filename and/or hyperlink. The system may also be configured to allow for manual entry of the name of the description, such that a user associated with an entity may manually recognize and enter the description to aid in the steps further described below.

Once the description and the creator(s) of the one or more electronic resources has been ascertained by the system, the process continues in block 406 by querying a database of electronic resource transfers using the creator and/or the description. The database may comprise a singular database compiled by the entity of all resource transfers of electronic resources, or in some embodiments, there may comprise multiple databases either maintained by the entity or maintained by a 3^{rd} party. Furthermore, the system in some embodiments may have only been able to determine a description, “shoes”, for the one or more electronic resources, and unable to locate a creator, and in this embodiment the system would query a database for all recorded electronic resource transfers for “shoes”. In other embodiments, the system may have determined the creator and the description for one or more electronic resources, and as such the system may query the database for “shoes, John's Shoe Company”.

Once the system has queried the database, the process continues in block 408 by identifying relevant resource transfers in the database. Continuing with the previous examples, the system identifies and locates all relevant resource transfers for “shoes” or “shoes, John's Shoe Company”, and the system will gather relevant recorded resource transfers associated with similar electronic resources. As previously noted, this identification may occur on a singular database maintained by the entity, or in some instances the system is configured to identify the relevant recorded resources transfers across a plurality of databases maintained by a 3^{rd} party. The system compiles the information found during the querying process in order to fulfill the identification process, and in this way the identification process is the output of the querying process. The information gathered by this process will be handled later in the process.

In block 410, the process continues by exporting a compiled list of relevant recorded resource transfers. The system is configured to take the identified relevant recorded resource transfers and record them into one or more documents of various type for usage in later processes. In some embodiments, the system may be configured to compile and export the identified relevant recorded resource transfers into spreadsheets. In other embodiments, the system may be configured to compile and export the identified relevant recorded resource transfers in a comma-separated value (“CSV”) document. In yet additional embodiments, the system may be configured to compile and export the identified relevant recorded resource transfers in common data format configurations such as XML, TSV, JSON, or the like.

FIG. 5 illustrates a block diagram 500 of a system and method for assigning a score to one or more electronic resources. The process begins in block 502 by assigning a relevance level for the identified relevant recorded resource transfers. In this way, the system is configured to receive the identified relevant recorded resource transfers illustrated in FIG. 4, in a data format such as a spreadsheet file, CSV, XML, TSV, JSON, or the like. Since electronic resources often represent unique resources of which there are no or very few identical electronic resources elsewhere in the database(s), the system in configured to determine the relevance of the one or more electronic resources associated with a user and those identified as relevant recorded resource transfers. In some embodiments, the one or more electronic resources associated with a user may have a plurality of identical electronic resources identified in the database(s) as relevant recorded resource transfers. In any scenario, the system is configured in block 502 to assign a relevance level, or confidence interval as it may be named, to the relevant resource transfers identified in previous steps of the process. The system may take attributes such as creator name, description, type of electronic resource, or the like from the one or more electronic resources associated with the user and implement a query of the data in a list in the format such as a spreadsheet file, CSV, XML, TSV, JSON, or the like, and return a numerical value that describes how closely related the relevant recorded resource transfers (and thereby electronic resources) in the list are to the one or more electronic resources associated with the user. If the numerical value is high, this may indicate that the attributes in the list are closely related to the attributes of the one or more electronic resources associated with the user. Similarly, if the numerical value is low, this indicates that the attributes in the list are not closely related to the attributes of the one or more electronic resources associated with the user. In this way, the system returns a numerical value that indicates relevance. This relevance level will be utilized by giving meaning to outputs of other processes outlined in further detail below. It shall be understood that each of the entries in the list of relevant recorded resource transfers is accompanied by a monetary value of each of the resource transfers associated with each item in the list. In situations where there is no resource transfer information available, the item may be purged from the list altogether. In some embodiments, it may be necessary for the system to parse one or more additional external databases for information about the value of any relevant recorded resource transfer associated with one or more electronic resources.

Process 500 continues with block 504, where the system is configured to model a value forecast of the one or more electronic resources associated with the user. In some embodiments, a forecast is modeled, or calculated, for the one or more electronic resources for a specific date in the future, as may be indicated by the time period defined by the obligation request by the user. In other embodiments, the entity may be interested in the present value of the one or more electronic resources associated with the user, and as such the value may be forecasted, or calculated, for the present date at the time the obligation request was initiated or anticipated to be implemented. In yet additional embodiments, the entity may be interested in knowing the overall trend of value(s) of the one or more electronic resources associated with the user, and as such the system may be configured to model the value forecast as a graphical or chart. The graph or chart or prediction model may be configured to be displayed on a user device of an entity such that a user associated with an entity is able to view the prediction model/forecast of the value of any particular electronic resource over any given period of time. The data used for the forecast, of any timeframe or statistical analysis, are provided to the system using the outputs of block 502, wherein there is a list provided to the system of relevant recorded resource transfers alongside the monetary value of each of the resource transfers associated with each item in the list.

The process continues in block 506 by determining a confidence level for the value forecast. In some embodiments, a particular type of electronic resource may be subject to a varying value when sold on an open market, such that the identified relevant recorded resource transfers for one or more electronic resources may return a wide range of prices. As such, it is important to identify how accurate any particular value forecast is by determining this range. In embodiments where the identified relevant recorded resource transfers are all very close to each other in value, the system may be configured to return a high confidence level. In embodiments where the identified relevant recorded resource transfers are not close to each other in value, the system may be configured to return a low confidence level. It shall be appreciated that medium confidence levels may be returned when the system identifies that some relevant recorded resource transfers are close to each other in value while others are not.

Process 500 concludes by assigning a score to the electronic resource, as illustrated in block 508. In some embodiments, assigning a score may comprise using the value forecast as previously illustrated and presenting the value forecast alongside the previously determined confidence level. As such, the value forecast may be mathematically weighed as a product of the confidence level and the value forecast to form a first score. Furthermore, in some embodiments, the first score may be combined as a weighted product with the relevance level determined in block 502 in order to determine a second score. As such, the electronic resource may be evaluated in further processes as illustrated in FIG. 3 in various ways, with the score comprising the first score, the second score, or both the first and second scores.

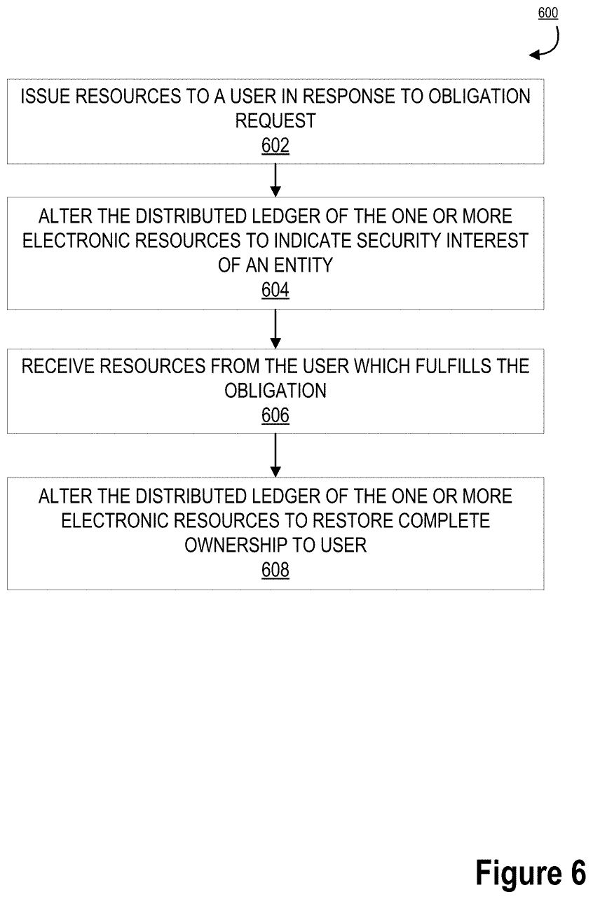

FIG. 6 illustrates process 600, where, in some embodiments, an entity may wish to retain a security interest in the one or more electronic resources as a result of issuing resources to the user. In this way, the record of the ownership on the distributed ledger may indicate that the entity has retained a security interest such as a lien, and therefore any additional obligation requests in the future will indicate that the owner is does not retain all of the rights to the electronic resource at the time of the obligation request.

The process begins at block 602, where the entity issues resources to a user in response to an obligation request. The process then continues at block 604, wherein the entity alters the distributed ledger associated with the one or more electronic resources associated with the user, provided that the electronic resource(s) were used by the entity in at least the process outlined in FIG. 3. Altering the distributed ledger may comprise adding an additional block to the distributed ledger indicating that the ownership of the electronic resource is now shared between the entity and the user, or that ownership remains with the user but the entity maintains some property rights in the electronic resource. In this way, if the user is unable to fulfill the obligation request by returning the resources to the entity, the entity may take full ownership of the electronic resource(s). In some embodiments, instead of adding an additional block to the distributed ledger, altering the distributed ledger may comprise altering the existing block of the distributed ledger with the indication of shared ownership or retained property rights.

The process 600 continues in block 606, wherein the user has returned the resources distributed to the user as a result of the obligation request, and the entity receives the resources from the user which fulfills the obligation. In this way, the obligation now no longer exists, and the user no longer owes any resources to the entity as it relates to the initial obligation request. In some embodiments, block 606 may occur at a different point during the obligation, such that perhaps when the majority of the resources have been returned to the entity, the obligation may be considered to be fulfilled for purposes of restoring ownership of the electronic resources as described below in block 608.

In block 608, as a result of receiving the resources from the user, the entity alters the distributed ledger of the one or more electronic resources to restore complete ownership to the user. Altering the distributed ledger may comprise adding an additional block to the distributed ledger indicating that the ownership of the electronic resource is now returned the user, and that the entity maintains no property rights in the electronic resource. In some embodiments, instead of adding an additional block to the distributed ledger, altering the distributed ledger may comprise altering the existing block of the distributed ledger with the indication of the user's ownership of the electronic resource.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for performing assessment of electronic resources stored in a distributed network, the system comprising:
a memory device with computer-readable program code stored thereon;
a communication device;
a processing device operatively coupled to the memory device and the communication device, wherein the processing device is configured to execute the computer-readable program code to:
receive, from a user on a user device, an obligation request, wherein the obligation request comprises a request from the user for resources from an entity;
parse and query a distributed ledger for electronic resources owned by the user;
identify and validate an ownership of one or more electronic resources associated with the user in the distributed ledger;
determine a creator of the one or more electronic resources by searching open-source or internal databases to match a filename of the one or more electronic resources to the creator;
receive, via manual entry, a description of the one or more electronic resources;
query a database of electronic resource transfers using text strings of the creator and the description; and
retain a security interest in the one or more electronic resources by altering the distributed ledger.

2. (canceled)

3. (canceled)

4. The system of claim 1, wherein the one or more electronic resources is a tokenized resource.

5. (canceled)

6. The system of claim 1, wherein the obligation request comprises the user receiving the resources in exchange for the user transferring the resources back to the entity within an agreed-upon timeframe, upon completion of which the user maintains the ownership of the one or more electronic resources.

7. (canceled)

8. A computer program product for performing assessment of electronic resources stored in a distributed network, the computer program product comprising at least one non-transitory computer-readable medium having computer-readable program code portions embodied therein, the computer-readable program code portions comprising:
an executable portion configured for receiving, from a user on a user device, an obligation request, wherein the obligation request comprises a request from the user for resources from an entity;
an executable portion configured for parsing and querying a distributed ledger for electronic resources owned by the user;
an executable portion configured for identifying and validating an ownership of one or more electronic resources associated with the user in the distributed ledger;
determine a creator of the one or more electronic resources by searching open-source or internal databases to match a filename of the one or more electronic resources to a creator;
receive, via manual entry, a description of the one or more electronic resources;
query a database of electronic resource transfers using text strings of the creator and the description; and
an executable portion configured for retaining a security interest in the one or more electronic resources by altering the distributed ledger.

9. (canceled)

10. (canceled)

11. The computer program product of claim 8, wherein the one or more electronic resources is a tokenized resource.

12. (canceled)

13. The computer program product of claim 8, wherein the obligation request comprises the user receiving the resources in exchange for the user transferring the resources back to the entity within an agreed-upon timeframe, upon completion of which the user maintains the ownership of the one or more electronic resources.

14. (canceled)

15. A computer-implemented method for performing assessment of electronic resources stored in a distributed network, the method comprising:
providing a computing system comprising a computer processing device and a non-transitory computer readable medium, where the non-transitory computer readable medium comprises configured computer program instruction code, such that when said computer program instruction code is operated by said computer processing device, said computer processing device performs the following operations:
receiving, from a user on a user device, an obligation request, wherein the obligation request comprises a request from the user for resources from an entity;
parsing and querying a distributed ledger for electronic resources owned by the user;
identifying and validating an ownership of one or more electronic resources associated with the user in the distributed ledger;
determining a creator of the one or more electronic resources by searching open-source or internal databases to match a filename of the one or more electronic resources to the creator;
receive, via manual entry, a description of the one or more electronic resources;
querying a database of electronic resource transfers using text strings of the creator and the description; and
retaining a security interest in the one or more electronic resources by altering the distributed ledger.

16. (canceled)

17. (canceled)

18. The computer-implemented method of claim 15, wherein the one or more electronic resources is a tokenized resource.

19-26. (Canceled)

27. The system of claim 1, wherein documentation associated the one or more electronic resources comprises the ownership derived from an ownership transfer, and wherein a value is obtained from a resource amount transferred during the ownership transfer.

28. The computer program product of claim 8, wherein documentation associated the one or more electronic resources comprises the ownership derived from an ownership transfer, and wherein a value is obtained from a resource amount transferred during the ownership transfer.

29. The computer-implemented method of claim 15, wherein documentation associated the one or more electronic resources comprises the ownership derived from an ownership transfer, and wherein a value is obtained from a resource amount transferred during the ownership transfer.
